(19) United States
(12) Patent Application Publication
(10) Pub. No.: US 2025/0245943 A1
(43) Pub. Date: Jul. 31, 2025

(54) DISPLAY DEVICE AND METHOD FOR OPERATING SAME

(71) Applicant: SAMSUNG ELECTRONICS CO., LTD., Suwon-si (KR)

(72) Inventors: Byungseok SOH, Suwon-si (KR); Bonseuk GOO, Suwon-si (KR); Youngtae KIM, Suwon-si (KR); Kisung LEE, Suwon-si (KR); Youngchol LEE, Suwon-si (KR); Weonhee LEE, Suwon-si (KR)

(73) Assignee: SAMSUNG ELECTRONICS CO., LTD., Suwon-si (KR)

(21) Appl. No.: 19/182,990

(22) Filed: Apr. 18, 2025

Related U.S. Application Data
(63) Continuation of application No. PCT/KR2023/015451, filed on Oct. 6, 2023.

(30) Foreign Application Priority Data
Oct. 18, 2022 (KR) 10-2022-0134470
Jan. 27, 2023 (KR) 10-2023-0011111

(51) Int. Cl. G06T 19/00; G06T 7/50; G06T 7/70; G06V 40/10; G06V 40/16; H04W 4/029

(52) U.S. Cl. CPC G06T 19/006; G06T 7/50; G06T 7/70; G06V 40/103; G06V 40/172; H04W 4/029; G06T 2207/30196

(57) ABSTRACT

According to embodiments, a display device and an operation method thereof are provided. A display device includes a communication interface; a display; a camera; at least one processor including processing circuitry; memory storing one or more instructions; and wherein the one or more instructions are configured to, when executed by the at least one processor individually or collectively, cause the display device to: obtain an image using the camera, identify an electronic device by controlling the communication interface while obtaining the image, obtain a registered avatar image associated with the electronic device, identify a user associated with the electronic device based on the image, and generate and display an augmented reality image associated with the image based on replacing at least a part of the user in the image with the registered avatar image.

### CROSS-REFERENCES TO RELATED APPLICATIONS

This application is a continuation of International Application No. PCT/KR2023/015451, filed on Oct. 6, 2023, with the Korean Intellectual Property Office, which claims priority from Korean Patent Application No. 10-2022-0134470, filed on Oct. 18, 2022, and Korean Patent Application No. 10-2023-0011111, filed on Jan. 27, 2023, with the Korean Intellectual Property Office, the disclosures of which are incorporated herein by reference in their entireties.

### BACKGROUND

### 1. Field

Various embodiments relate to a display device and an operation method thereof, and more particularly, to a display device for displaying an avatar and an operation method of the display device.

### 2. Background of Related Art

Augmented reality (AR) provides content for enhancing real-world experiences. AR displays display, on a screen, content that is not real but corresponds to a surrounding environment as seen by a user. AR displays may also replace a user's image included in AR content with an avatar.

### SUMMARY

According to an embodiment of the present disclosure, there are provided a display device and an operation method thereof capable of providing a registered avatar image corresponding to a user without causing privacy concerns.

Technical solutions to be achieved in the present disclosure are not limited to those described above, and other technical solutions not described will be clearly understood by one of ordinary skill in the art to which the present disclosure belongs from the following description.

According to an embodiment, the display device may include a communication interface; a display; a camera; at least one processor including processing circuitry; memory storing one or more instructions; and wherein the one or more instructions are configured to, when executed by the at least one processor individually or collectively, cause the display device to: obtain an image using the camera, identify an electronic device by controlling the communication interface while obtaining the image, obtain a registered avatar image associated with the electronic device, identify a user associated with the electronic device based on the image, and generate and display an augmented reality image associated with the image based on replacing at least a part of the user in the image with the registered avatar image.

According to an embodiment, the operation method of the display device may include obtaining an image using a camera; identifying an electronic device by controlling a communication interface while obtaining the image; obtaining a registered avatar image associated with the electronic device; identifying a user associated with the electronic device based on the image; and generating and displaying an augmented reality image associated with the image based on replacing at least a part of the user in the image with the registered avatar image.

According to an embodiment, a non-transitory computer-readable recording medium storing one or more instructions, the one or more instructions that when executed by a processor of an display device, cause the processor to: obtain an image using the camera, identify an electronic device by controlling a communication interface while obtaining the image, obtain a registered avatar image associated with the electronic device, identify a user associated with the electronic device based on the image, and generate and display an augmented reality image associated with the image based on replacing at least a part of the user in the image with the registered avatar image.

According to an embodiment, a display device, a method, and a non-transitory computer-readable storage medium are capable of providing an augmented reality image without causing privacy concerns by providing an avatar image corresponding to a user using an electronic device of the user without storing an image of the user's face in the display device.

The effects that may be obtained from embodiments disclosed in the present disclosure are not limited to those described above, and other effects that are not described will be clearly understood by one of ordinary skill in the art from the following description.

### BRIEF DESCRIPTION OF THE DRAWINGS

The foregoing and other aspects, features, and advantages of some embodiments of the present disclosure will be readily understood from the following detailed description taken in conjunction with the accompanying drawings.

FIG. 1 is a diagram illustrating an operation of a display device displaying an augmented reality (AR) image, according to various embodiments.

FIG. 2 illustrates an example of a system including a display device, an electronic device, and a server device, according to an embodiment.

FIG. 3 is a block diagram of an example of a display device, according to an embodiment.

FIG. 4 is a flowchart of an example of an operation method of a display device, according to an embodiment.

FIG. 5A illustrates, as an example, a flowchart of an operation of determining information about a relative position of an electronic device with respect to a display device, according to an embodiment.

FIG. 5B is a diagram illustrating a process of identifying an electronic device by using ultra-wideband (UWB) communication technology, according to an embodiment.

FIG. 5C is a diagram illustrating an operation of determining information about a relative position of a remote control device with respect to an electronic device as a reference, according to an embodiment.

FIG. 6 is a diagram illustrating examples of a display device obtaining avatar images corresponding to electronic devices, according to an embodiment.

FIG. 7 is a diagram illustrating a process of detecting a user in a captured image by using a skeleton detection technique, according to an embodiment.

FIG. 8 is a diagram illustrating a process of identifying a user associated with an identified electronic device by associating location information of the user included in an image with location information of the identified electronic device, according to an embodiment.

FIG. 9 illustrates a process of displaying an AR image by replacing a user included in an image with a registered avatar image corresponding to an electronic device associated with the user, according to an embodiment.

FIG. 10 is a flowchart of an example of an operation method of a display device for obtaining an avatar image from a server device, according to an embodiment.

FIG. 11 is a flowchart of an example of an operation method of a display device for obtaining an avatar image from an electronic device, according to an embodiment.

FIG. 12 is a flowchart of an example of an operation method of a display device for replacing a facial image with an avatar image, according to an embodiment.

FIG. 13 is a diagram illustrating a concept of a method of displaying an avatar by setting an avatar display mode to a decorate mode and a hide mode based on a user's selection, according to an embodiment.

FIG. 14 is a flowchart of an example of an operation method of an electronic device and a display device based on an avatar display mode, according to an embodiment.

FIG. 15 is a diagram illustrating an example of outputting an image by hiding or displaying a user in a decorate mode based on an avatar display mode, according to an embodiment.

### DETAILED DISCLOSURE

Terms used in the present specification will now be briefly described and then the present disclosure will be described in detail.

As the terms used herein, general terms that are currently widely used are selected by taking into account functions according to the present disclosure, but the terms may vary according to the intention of one of ordinary skill in the art, precedent cases, advent of new technologies, etc. Furthermore, specific terms may be arbitrarily selected by the applicant, and in this case, the meaning of the selected terms will be described in detail in a corresponding part of the detailed description of the disclosure. Thus, the terms used in the present disclosure should be defined not by simple appellations thereof but based on the meaning of the terms together with the overall description of the present disclosure.

Throughout the specification, when a part “includes” or “comprises” an element, unless there is a particular description contrary thereto, it is understood that the part may further include other elements, not excluding the other elements. In addition, terms such as “unit”, “module”, etc., described in the specification refer to a unit for processing at least one function or operation and may be implemented as hardware or software, or a combination of hardware and software.

Embodiments will be described more fully hereinafter with reference to the accompanying drawings so that they may be easily implemented by one of ordinary skill in the art. However, the present disclosure may be implemented in different forms and should not be construed as being limited to embodiments set forth herein. In addition, parts not related to descriptions of the present disclosure are omitted to clearly explain the present disclosure in the drawings, and like reference numerals denote like elements throughout.

In an embodiment in the present specification, the term “user” refers to a person who controls a function or operation of a computing apparatus or an electronic device by using a control device, and may include a viewer, an administrator, or an installation engineer.

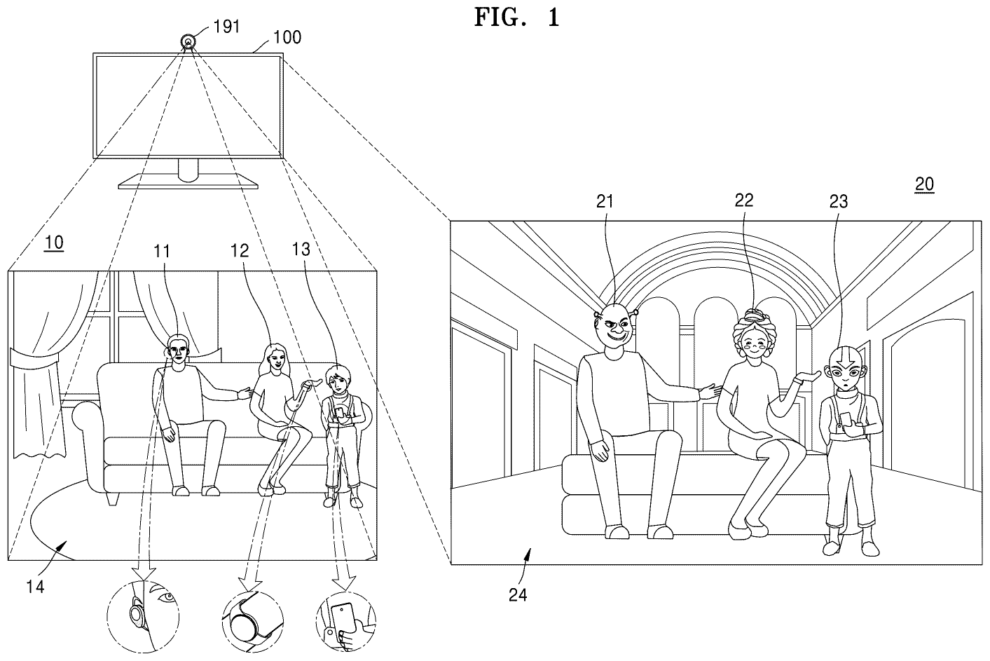

FIG. 1 is a reference diagram illustrating an operation of a display device displaying an augmented reality (AR) image, according to various embodiments.

Referring to FIG. 1, a display device 100 may capture an image of an external environment by using a camera 191, and generate and display an AR image 20 corresponding to a captured external environment image 10. In embodiments, the display device 100 may be an AR device configured to display an AR image. AR is a technology that superimposes a three-dimensional (3D) virtual image on a real-world image or background and presents this overlay as a single image, and may refer to presenting virtual images by replacing one or more objects or background in a captured image with 3D virtual images. For example, the external environment image 10 captured by the display device 100 in FIG. 1 may include users 11, 12, 13 as one or more objects, and a background 14. The display device 100 may generate, in correspondence to the external environment image 10 captured in this way, the AR image 20 in which one or more objects or backgrounds are overlaid as 3D virtual images. Referring to FIG. 1, the display device 100 may generate the AR image 20 in which the background 14 is replaced with a 3D virtual image, a face of the user 11 is replaced with a first avatar image 21, a face of the user 12 is replaced with a second avatar image 22, and a face of the user 13 is replaced with a third avatar image 23.

In order to replace an image of each user included in the external environment image 10 with a corresponding avatar image of that user, the display device 100 may need to recognize each user in the external environment image 10 that is to be replaced with a corresponding avatar image. To accomplish this, a method may be generally considered in which an image of a user's face and a corresponding avatar image are stored in the display device 100 or a server device connected to the display device 100, and the display device 100 recognizes the user's face in an image captured by the display device 100, finds an avatar image corresponding to an image of the recognized face, and replaces the user's face with the avatar image. However, storing an image of the user's face in a place such as a display device or a server device in this way may cause privacy concerns. Therefore, a method of providing an avatar image without causing privacy concerns is required.

Accordingly, according to disclosed various embodiments, the display device 100 may replace a user included in an image captured by the display device 100 with an avatar image stored in association with a terminal device or electronic device used by the user, instead of an avatar image stored in association with the user's face. By associating the avatar image with the electronic device used by the user as described above, rather than with the user's face, the display device 100 may identify the user in the captured image by using the electronic device of the user without having to store an image of the user's face.

According to disclosed various embodiments, the display device 100 may receive an image of a user's face from an electronic device of the user, and replace the user included in an image captured by the display device 100 with an avatar image corresponding to the image of the user's face. Even when the avatar image is obtained by using the image of the user's face in this way, the image of the user's face is not stored in the display device 100 or the server device connected to the display device 100, but is only temporarily received from the electronic device of the user, used for recognition, and then discarded, thereby eliminating the possibility of causing privacy problems because the image of the user's face is not stored in the display device 100 or the server device.

According to disclosed various embodiments, the display device 100 may hide an image of a user included in an image captured by the display device 100 or replace the image of the user with an avatar image according to settings of an electronic device of a user with which the display device 100 communicates. In embodiments, the hiding of the image of the user may include at least one of obstructing the user or at least a part of the user in the image, concealing the user or at least a part of the user in the image, displaying a mask instead of the user or at least a part of the user in the image, overlaying a graphic on the user or at least a part of the user in the image, or blurring the user or at least a part of the user in the image. In this way, depending on avatar display mode settings on the electronic device, the display device 100 may hide the anonymous user or display the avatar image when one or more users are included in the captured image.

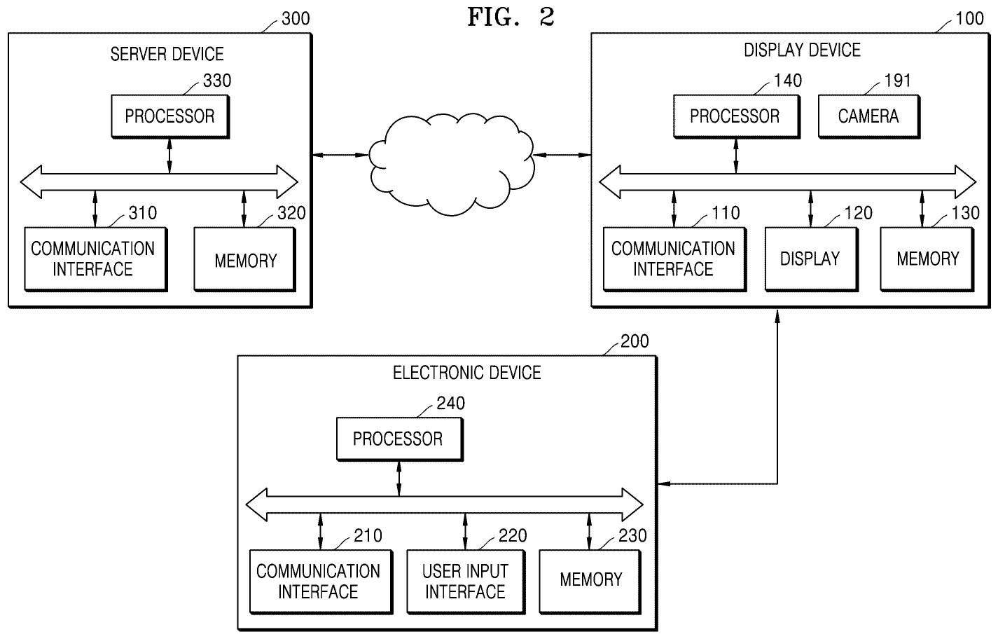

FIG. 2 illustrates an example of a system including a display device, an electronic device, and a server device, according to an embodiment.

Referring to FIG. 2, the system may include a display device 100, an electronic device 200, and a server device 300, which are all connected to a communication network.

The display device 100 is a device capable of displaying images or data according to a user's request, and may include a communication interface 110, a display 120, memory 130, a camera 191, and a processor 140.

The communication interface 110 may include one or more modules that enable wireless communication between the display device 100 and a wireless communication system or between the display device 100 and a network on which another device is located. The communication interface 110 may include one or more communication circuits. According to an embodiment, the communication interface 110 may perform communication with the electronic device 200 according to a short-range communication technology. Short-range communication technologies may include, for example, Bluetooth communication, Wi-Fi communication, Infrared Data Association (IrDA), ultra-wideband (UWB) communication, etc. According to an embodiment, the communication interface 110 may perform communication with the server device 300 according to an Internet Protocol (IP).

According to an embodiment, the communication interface 110 may include an antenna for performing communication. For example, the display device 100 may include a UWB antenna for performing UWB communication.

The display 120 may output images or data processed by the display device 100.

The memory 130 may store programs necessary for processing or control by the processor 140, and store data input to or output from the display device 100. Furthermore, the memory 140 may store pieces of data necessary for operation of the display device 100.

The memory 130 may include at least one type of storage medium from among a flash memory-type memory, a hard disk-type memory, a multimedia card micro-type memory, a card-type memory (e.g., a Secure Digital (SD) card or an Extreme Digital (XD) memory), random access memory (RAM), static RAM (SRAM), read-only memory (ROM), electrically erasable programmable ROM (EEPROM), PROM, a magnetic memory, a magnetic disc, and an optical disc.

The camera 191 may obtain an image by performing image capturing. For example, the camera 191 may include a two-dimensional (2D) camera, such as a red, green, and blue (RGB) camera, or a 3D camera, such as a depth camera, and the 3D camera may utilize a time of flight (ToF) method, a radio frequency (RF) imaging method, a structured light method, or a photometric stereo method.

The processor 140 controls all operations of the display device 100. For example, the processor 140 may execute one or more instructions stored in the memory 130 to perform functions of the display device 100 described in the present disclosure. The processor 140 may consist of one or more processors.

In an embodiment of the present disclosure, the processor 140 may store one or more instructions in an internal memory provided therein, and execute the one or more instructions stored in the internal memory to control operations of the display device 100 to be performed. In other words, the processor 140 may execute at least one instruction or program stored in the internal memory provided in the processor 140 or the memory 130 to perform predetermined operations.

According to an embodiment, the processor 140 may execute one or more instructions stored in the memory 130 to perform operations of the display device 100 described in the present disclosure.

According to an embodiment, the processor 140 may be configured to execute one or more instructions stored in the memory 130 to obtain an image of an external environment by controlling the camera 191 to perform image capturing.

According to an embodiment, the processor 140 may be configured to execute one or more instructions stored in the memory 130 to identify an electronic device by controlling the communication interface 110 during the image capturing.

According to an embodiment, the processor 140 may be configured to execute one or more instructions stored in the memory 130 to obtain location information of the electronic device and identification information of the electronic device by using Bluetooth Low Energy (BLE) communication technology or UWB communication technology.

According to an embodiment, the processor 140 may be configured to execute one or more instructions stored in the memory 130 to obtain a registered avatar image corresponding to the identified electronic device.

According to an embodiment, the processor 140 may be configured to execute one or more instructions stored in the memory 130 to identify a registered avatar image corresponding to the electronic device by receiving the registered avatar image from a server, obtaining the avatar image from memory of the display device 100, or receiving the avatar image from the electronic device 200 via a communication interface 110 by using identification information of the electronic device.

According to an embodiment, the processor 140 may be configured to execute one or more instructions stored in the memory 130 to identify a user associated with the identified electronic device from the image.

According to an embodiment, the processor 140 may be configured to execute one or more instructions stored in the memory 130 to obtain location information of the user included in the image by analyzing the image.

According to an embodiment, the processor 140 may be configured to execute one or more instructions stored in the memory 130 to detect one or more users in the image by performing skeleton detection in the image.

According to an embodiment, the processor 140 may be configured to execute one or more instructions stored in the memory 130 to identify a user associated with the electronic device by using location information of the user detected in the image and location information of the electronic device.

According to an embodiment, the processor 140 may be configured to execute one or more instructions stored in the memory 130 to identify a user whose distance from the electronic device is less than or equal to a threshold as a user associated with the electronic device.

According to an embodiment, the processor 140 may be configured to execute one or more instructions stored in the memory 130 to receive, from the electronic device, a facial image of a user of the electronic device and identify the user associated with the electronic device by recognizing the facial image in the image.

According to an embodiment, the processor 140 may be configured to execute one or more instructions stored in the memory 130 to generate and display an AR image by replacing at least a part of a body of the user identified in the image with the avatar image.

According to an embodiment, the processor 140 may execute one or more instructions stored in the memory 130 to generate and display an AR image by replacing at least a part of the body of the identified user in the image with the avatar image.

According to an embodiment, the processor 140 may be configured to execute one or more instructions stored in the memory 130 to receive information about an avatar display mode from the electronic device and hide a user identified in the image or display an avatar image of the user based on the information about the avatar display mode.

According to an embodiment, the processor 140 may be configured to execute one or more instructions stored in the memory 130 to display at least a part of the user identified in the image as the avatar image based on the avatar display mode indicating a decorate mode, and to hide the at least the part of the user identified in the image based on the avatar display mode indicating a hide mode.

The display device 100 may be any type of device that performs functions by including a processor and memory. The display device 100 may be a stationary or portable device. For example, the display device 100 may refer to a device having a display that is capable of displaying image content, video content, game content, graphic content, etc. The display device 100 may output or display an image or content received from the server device 300. For example, the display device 100 may include various types of electronic devices capable of receiving and outputting content, such as televisions (TVs) such as network TVs, smart TVs, Internet TVs, web TVs, and IPTVs, computers such as desktops, laptops, and tablets, various smart devices such as smartphones, cellular phones, game players, music players, video players, medical equipment, and home appliances, etc. The display device 100 may be referred to as a display device because it receives and displays content, and may also be referred to as a content receiving device, a sink device, an electronic device, a computing device, etc.

The processor 140 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and (an)other processor(s) performs others of the recited functions, and also situations in which a single processor may perform all recited functions. Additionally, the at least one processor may include a combination of processors performing a variety of the recited/disclosed functions, e.g., in a distributed manner. At least one processor may execute program instructions to achieve or perform various functions.

A block diagram of the display device 100 illustrated in FIG. 2 is a block diagram for an embodiment. Each of the components in the block diagram may be integrated, added, or omitted according to the specification of the display device 100 that is actually implemented. For example, two or more components may be combined into a single component, or a single component may be subdivided into two or more components, as needed. Furthermore, functions performed by each block are intended to describe embodiments, and a specific operations or device related to the functions does not limit the scope of the present disclosure.

The electronic device 200 is described.

The electronic device 200 may include a communication interface 210, a user input interface 220, memory 230, and a processor 240. However, the electronic device 200 may be implemented with more components than those shown in FIG. 2, and is not limited to the above example.

The communication interface 210 may include one or more modules that enable wireless communication between the display device 100 and a wireless communication system or between the display device 100 and a network on which another device is located. The communication interface 210 may include one or more communication circuits. According to an embodiment, the communication interface 210 may perform communication with the display device 100 according to a short-range communication technology. Short-range communication technologies may include, for example, Bluetooth communication, Wi-Fi communication, IrDA, UWB communication, etc. According to an embodiment, the communication interface 210 may perform communication with the server device 300 according to an IP.

According to an embodiment, the electronic device 200 may include a plurality of antennas for performing communication (e.g., UWB communication) with the display device 100.

The user input interface 220 may be any form of interface capable of receiving a user input. For example, the user input interface 220 may include manipulation buttons, arranged on a portion of the electronic device 200, capable of receiving a user input, a touch-sensitive display configured to detect a touch input, a microphone capable of receiving a voice uttered by the user, etc.

The memory 230 may store programs necessary for processing or control by the processor 240, and store data input to or output from the electronic device 200.

The memory 230 may include at least one type of storage medium from among a flash memory-type memory, a hard disk-type memory, a multimedia card micro-type memory, a card-type memory (e.g., an SD card or an XD memory), RAM, SRAM, ROM, EEPROM, PROM, a magnetic memory, a magnetic disc, and an optical disc.

The processor 240 controls all operations of the electronic device 200. For example, the processor 240 may execute one or more instructions stored in the memory 230 to perform functions of the electronic device 200 described in the present disclosure.

In an embodiment of the present disclosure, the processor 240 may store one or more instructions in an internal memory provided therein, and execute the one or more instructions stored in the internal memory to control the above-described operations to be performed. In other words, the processor 240 may execute at least one instruction or program stored in the internal memory provided in the processor 240 or the memory 230 to perform predetermined operations.

According to an embodiment, the processor 240 may execute one or more instructions stored in the memory 130 to perform UWB communication with the display device 100.

According to an embodiment, by executing one or more instructions stored in the memory 230, the processor 240 may perform communication with the server device 300 to store an avatar image corresponding to the electronic device 200 in a database of the electronic device 200 or register the avatar image with the server device 300 according to a user input.

According to an embodiment, the processor 240 may execute one or more instructions stored in the memory 230 to transmit the registered avatar image corresponding to the electronic device 200 to the display device 100 in response to a request from the display device 100.

According to an embodiment, the processor 240 may execute one or more instructions stored in the memory 230 to set an avatar display mode of the electronic device 200 to one of a hide mode and a decorate mode according to a user input.

According to an embodiment, the processor 240 may execute one or more instructions stored in the memory 230 to transmit a response corresponding to an avatar display mode set in the electronic device 200 in response to an avatar image request from the display device 100. For example, when the avatar display mode is a hide mode, the electronic device 200 may transmit a response indicating the hide mode to the display device 100. For example, when the avatar display mode is a decorate mode, the electronic device 200 may transmit, to the display device 100, a response indicating the decorate mode together with the avatar image.

The electronic device 200 may be any type of device that performs functions by including a processor and memory. The electronic device 200 may include various electronic devices, such as a remote electronic device, a gaming electronic device, a smartphone, etc.

Moreover, a block diagram of the electronic device 200 illustrated in FIG. 2 is a block diagram for an embodiment. Each of the components in the block diagram may be integrated, added, or omitted according to the specification of the electronic device 200 that is actually implemented. For example, two or more components may be combined into a single component, or a single component may be split into two or more components when necessary. Furthermore, functions performed by each block are intended to describe embodiments, and a specific operation or device related to the functions does not limit the scope of the present disclosure.

The server device 300 is now described.

The server device 300 may include a communication interface 310, memory 320, and a processor 330. However, the server device 300 may be implemented with more components than those shown in FIG. 2, and is not limited to the above example. For example, the server device 300 may have a separate image processor for performing image processing on images for an application executed on the server device 300.

The communication interface 310 may include one or more modules that enable wireless communication between the server device 300 and a wireless communication system or between the server device 300 and a network on which another device is located. The communication interface 310 may include one or more communication circuits. According to an embodiment, the communication interface 310 may perform communication with the display device 100 according to an IP. According to an embodiment, the communication interface 310 may perform communication with the electronic device 200 according to an IP.

The memory 320 may store programs necessary for processing or control by the processor 330, and store data input to or output from the server device 300.

The memory 320 may include at least one type of storage medium from among a flash memory-type memory, a hard disk-type memory, a multimedia card micro-type memory, a card-type memory (e.g., an SD card or an XD memory), RAM, SRAM, ROM, EEPROM, PROM, a magnetic memory, a magnetic disc, and an optical disc.

The processor 330 controls all operations of the server device 300. For example, the processor 330 may execute one or more instructions stored in the memory 320 to perform functions of the server device 300 described in the present disclosure.

In an embodiment of the present disclosure, the processor 330 may store one or more instructions in an internal memory provided therein, and execute the one or more instructions stored in the internal memory to control the above-described operations to be performed. In other words, the processor 330 may execute at least one instruction or program stored in the internal memory provided in the processor 330 or the memory 330 to perform predetermined operations.

According to an embodiment, the processor 330 may execute one or more instructions stored in the memory 320 to register an avatar image corresponding to the electronic device 200 in a database in response to a request from the electronic device 200 or the display device 100.

According to an embodiment, the processor 330 may execute one or more instructions stored in the memory 320 to transmit the avatar image corresponding to the electronic device 200 to the display device 100 in response to an avatar image request from the display device 100.

A block diagram of the server device 300 illustrated in FIG. 2 is a block diagram for an embodiment. Each of the components in the block diagram may be integrated, added, or omitted according to the specification of the server device 300 that is actually implemented. For example, two or more components may be combined into a single component, or a single component may be subdivided into two or more components, as needed. Furthermore, functions performed by each block are intended to describe embodiments, and a specific operation or device related to the functions does not limit the scope of the present disclosure.

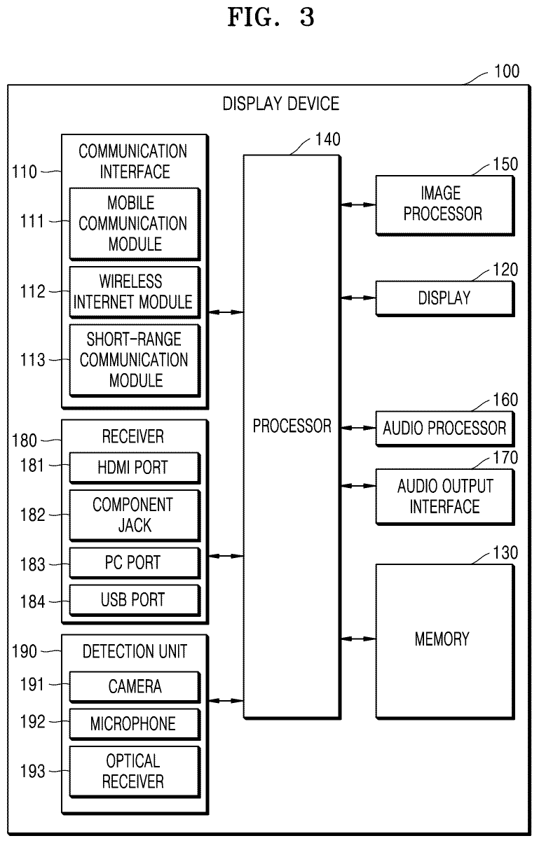

FIG. 3 is a block diagram of an example of a display device, according to an embodiment.

Referring to FIG. 3, the display device 100 may include, in addition to the communication interface 110, the display 120, the memory 130, and the processor 140, an image processor 150, an audio processor 160, an audio output interface 170, a receiver 180, and a detection unit 190.

The communication interface 110 may include one or more modules that enable wireless communication between the display device 100 and a wireless communication system or between the display device 100 and a network on which another electronic device is located. For example, the communication interface 110 may include a mobile communication module 111, a wireless Internet module 112, and a short-range communication module 113.

The mobile communication module 111 transmits or receives wireless signals to or from at least one of a base station, an external terminal, and a server on a mobile communication network. The wireless signals may include a voice call signal, a video call signal, or various forms of data according to transmission and reception of text/multimedia messages.

The wireless Internet module 112 refers to a module for wireless Internet access, and may be built into or external to the display device 100. As wireless Internet technologies, wireless local area network (WLAN) (e.g., WiFi), wireless broadband (WiBro), World Interoperability for Microwave Access (WiMAX), high speed downlink packet access (HSDPA), etc. may be used. The display device 100 may establish a Wi-Fi peer-to-peer (P2P) connection with another device via the wireless Internet module 112.

The short-range communication module 113 refers to a module for short-range communication. As short-range communication technologies, Bluetooth, BLE, radio frequency identification (RFID), IrDA, UWB, ZigBee, etc. may be used.

The display 120 may display am image signal received from the server device 300 on a screen.

The memory 130 may store programs related to operation of the display device 100, various pieces of data generated during the operation of the display device 100.

The memory 130 may store at least one instruction. Furthermore, the memory 130 may store at least one instruction executed by the processor 140. Furthermore, the memory 130 may store at least one program executed by the processor 140. Furthermore, the memory 130 may store an application for providing a predetermined service.

In detail, the memory 130 may include at least one type of storage medium from among a flash memory-type memory, a hard disk-type memory, a multimedia card micro-type memory, a card-type memory (e.g., an SD card or an XD memory), RAM, SRAM, ROM, EEPROM, PROM, a magnetic memory, a magnetic disc, and an optical disc.

The processor 140 controls all operations of the display device 100. For example, the processor 140 may execute one or more instructions stored in the memory 130 to perform functions of the display device 100 described in the present disclosure.

In an embodiment of the present disclosure, the processor 140 may store one or more instructions in an internal memory provided therein, and execute the one or more instructions stored in the internal memory to control operations of the display device to be performed. In other words, the processor 140 may execute at least one instruction or program stored in the internal memory provided in the processor 140 or the memory 130 to perform predetermined operations.

That is, the processor 140 may execute at least one instruction to control an intended operation to be performed. In this case, the at least one instruction may be stored in the internal memory included in the processor 140 or the memory 130 included in the display device 100 separately from the processor 140.

The processor 140 may execute the at least one instruction to control at least one component included in the display device 100 so that an intended operation is performed. Thus, even when it is described that the processor 140 performs predetermined operations, it may be understood that the processor 140 controls the at least one component included in the display device 100 so that the predetermined operations are performed.

In addition, although the processor 140 is described and illustrated as being formed as a single processor, the processor 140 may also be formed by including a plurality of processors.

For example, the processor 140 may include RAM that stores signals or data input from outside of the display device 100 or is used as a storage area corresponding to various operations performed by the display device 100, ROM storing a control program for controlling the display device 100, an application for providing a predetermined function or service, and/or a plurality of instructions, and at least one processor. The processor 140 may include a graphics processing unit (GPU) (not shown) for processing graphics corresponding to a video. The processor 140 may be implemented as a system on chip (SOC) in which a core (not shown) is integrated with the GPU. Furthermore, the processor 140 may include multiple cores that are more than a single core. For example, the processor 140 may include dual-core, triple-core, quad-core, hexa-core, octa-core, deca-core, dodeca-core, hexadeca-core, etc.

According to control by the processor 140, the image processor 150 may process an image signal received from the receiver 180 or the communication interface 110 and output a result to the display 120.

According to control by the processor 140, the audio processor 160 may convert an audio signal received from the receiver 180 or the communication interface 110 into an analog audio signal and output the analog audio signal to the audio output interface 170.

The audio output interface 170 may output audio (e.g., a voice and a sound) input via the communication interface 110 or the receiver 180. Furthermore, the audio output interface 170 may output audio stored in the memory 130 according to control by the processor 140. The audio output interface 170 may include at least one of a speaker, a headphone output terminal, or a Sony/Phillips Digital Interface (S/PDIF) output terminal, or a combination thereof.

The receiver 180 may receive video (e.g., moving images, etc.), audio (e.g., voice, music, etc.), and additional information (e.g., electronic program guide (EPG), etc.) from outside the display device 100 under the control of the processor 140. The receiver 180 may include one of a high-definition multimedia interface (HDMI) port 181, a component jack 182, a PC port 183, and a universal serial bus (USB) port 184, or a combination of one or more thereof. The receiver 180 may further include, in addition to the HDMI port 181, a display port (DP), a Thunderbolt, and a mobile high-definition link (MHL).

The detection unit 190 detects a user's voice, images, or interactions, and may include a camera 191, a microphone 192, and an optical receiver 193.

In detail, the camera 191 may receive images (e.g., consecutive frames) corresponding to the user's motion including his or her gesture within a recognition range of the camera 191. The processor 140 may select a menu displayed on the display device 100 by using a received motion recognition result or perform control corresponding to the motion recognition result. For example, the display device 100 may capture an image of an external environment by using a 2D camera, such as an RGB camera, or a 3D camera, such as a depth camera. The 3D camera may use a ToF method, an RF imaging method, a structured light method, or a photometric stereo method.

The microphone 192 may receive a voice uttered by the user. The microphone 192 may convert the received voice into an electrical signal and output the electrical signal to the processor 140. The user's voice may include, for example, a voice corresponding to a menu or function of the display device 100.

The optical receiver 193 receives an optical signal (including a control signal) received from an external control device. The optical receiver 193 may receive, from the control device, an optical signal corresponding to a user input (e.g., touching, pressing, touch gesture, voice, or motion). A control signal may be extracted from the received optical signal according to control by the processor 140.

The processor 140 controls all the operations of the display device 100 and a flow of signals between the internal components of the display device 100, and performs a function of processing data. When there is an input by the user or preset and stored conditions are satisfied, the processor 140 may execute an operating system (OS) and various applications stored in the memory 130.

The processor 140 may include a GPU (not shown) for processing graphics corresponding to a video. The GPU (not shown) generates a screen including various objects such as icons, images, and text by using a computation unit (not shown) and a rendering unit (not shown). The computation unit calculates attribute values such as coordinate values, shape, size, and color for each object to be displayed according to a layout of the screen by using a user interaction detected via a detection unit 190. The rendering unit generates screens with various layouts including objects based on the attribute values calculated by the computation unit.

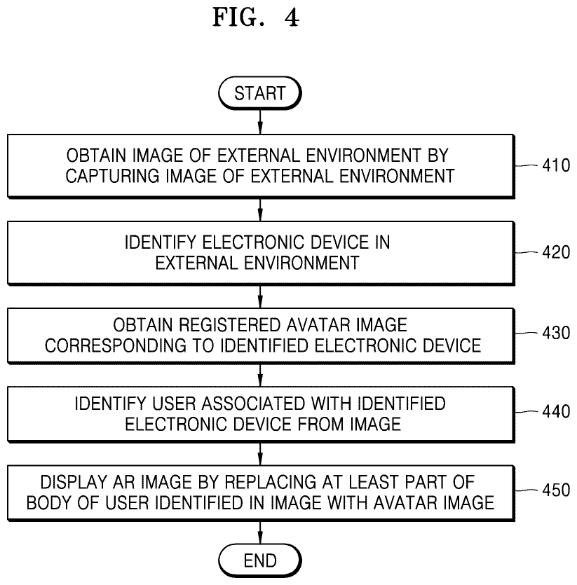

FIG. 4 is a flowchart of an example of an operation method of a display device, according to an embodiment.

Referring to FIG. 4, in operation 410, the display device 100 may obtain an image of an external environment by capturing the image of the external environment. For example, the display device 100 may capture the image of the external environment by using a 2D camera, such as an RGB camera, or a 3D camera, such as a depth camera. The 3D camera may use a ToF method, an RF imaging method, a structured light method, or a photometric stereo method.

In operation 420, the display device 100 may identify the electronic device 200 in the external environment surrounding the display device 100. The display device 100 may identify an electronic device by detecting and communicating with one or more electronic devices in the external environment surrounding the display device 100 via a communication interface while capturing an image of the external environment by using a camera.

According to an embodiment, the display device 100 may obtain identification information of the electronic device and/or location information of the electronic device by identifying the electronic device.

According to an embodiment, the display device 100 may obtain identification information of the electronic device and/or location information of the electronic device by using BLE communication technology.

According to an embodiment, the display device 100 may obtain identification information of the electronic device and/or location information of the electronic device by using UWB communication technology.

UWB communication is a communication technology for transmitting signals by using very short pulses (on the order of a few nanoseconds) at low power over a large bandwidth compared to existing communications. In the past, UWB technology was used for military purposes such as military radar and remote sensing, but since the U.S. Federal Communications Commission (FCC) approved its commercial use in 2002, limited to indoor wireless communications, its applications have expanded into various fields. Through UWB communication, the time of arrival (ToA), which is the time it takes for a pulse to reach a target, and the angle of arrival (AoA) of a pulse at a transmitter may be accurately measured, and thus precise indoor distance and location recognition with an error of tens of centimeters (cm) may be achieved.

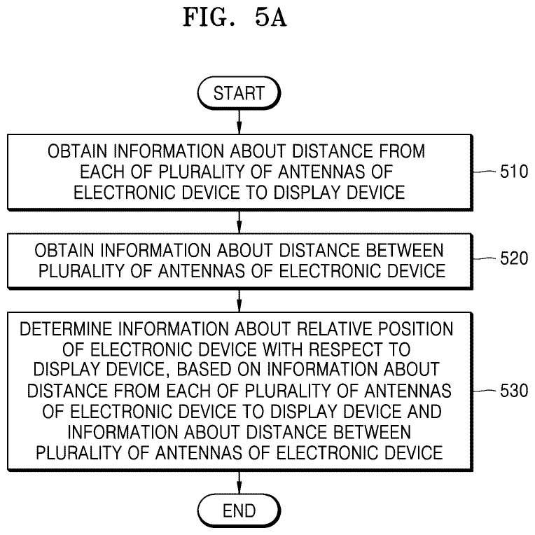

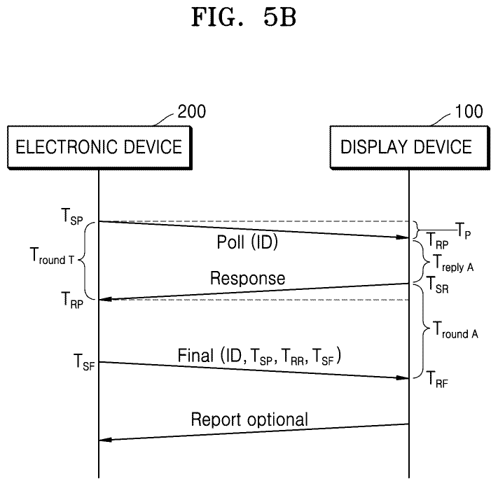

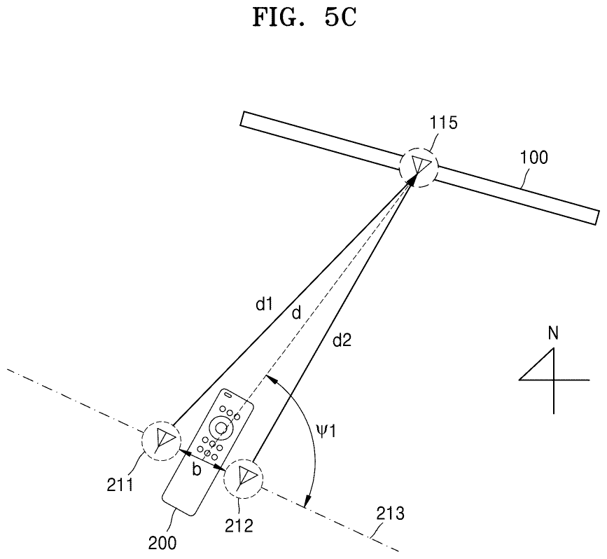

A method of identifying an electronic device by using UWB communication technology, according to an embodiment, is described with reference to FIGS. 5A to 5C.

FIG. 5A illustrates, as an example, a flowchart of an operation of determining information about a relative position of an electronic device with respect to a display device, according to an embodiment.

Referring to FIG. 5A, in operation 510, the display device 100 may obtain information about a distance from each of a plurality of antennas of the electronic device 200 to the display device 100.

FIG. 5B is a reference diagram illustrating a method of identifying an electronic device by using UWB communication technology, according to an embodiment.

According to various embodiments, the display device 100 or the processor 140 of the display device 100 may calculate a distance to an external electronic device via a UWB signal. As described with reference to FIG. 2, the display device 100 may include a UWB antenna 115 of FIG. 5C for performing UWB communication. The UWB antenna 115 of the display device 100 may include at least one processor distinct from the processor 140, and a distance to an external electronic device may be calculated based on a UWB signal. The at least one processor included in the UWB antenna 115 may generate data or information, including time information, based on the UWB signal, and provide the data or information to the processor 140 of the display device 100. The processor 140 may calculate a distance to the external electronic device based on the provided data or information.

According to an embodiment, the processor 140 of the display device 100 may use methods such as AoA, time of arrival (ToA), and time difference of arrival (TDoA) to calculate a distance to the external electronic device.

FIG. 5B is a reference diagram illustrating a process of calculating a distance between the display device 100 and the electronic device 200 based on a ToA method, according to an embodiment.

Referring to FIG. 5B, the processor 140 of the display device 100 may calculate a distance between the display device 100 and the electronic device 200 by using a two way ranging (TWR) method in which signals are exchanged between the display device 100 and the electronic device 200. The electronic device 200 may be referred to as a UWB tag device, and the display device 100 may be referred to as a UWB anchor device.

According to an embodiment, the electronic device 200 may transmit a poll signal to the display device 100. Upon receiving the poll signal, the display device 100 may transmit a response signal to the electronic device 200. Upon receiving the response signal, the electronic device 200 may transmit a final signal to the display device 100. T_{round T} that is a round trip time (RTT) of the signal transmitted by the electronic device 200 may be measured through the time T_{SP} when the poll signal is transmitted and the time T_{RR} when the response signal is received. T_{reply A} that is a reply delay time of the display device 100 may be measured through the time T_{RP} when the poll signal is received and the time T_{SR} when the response signal is transmitted. Because the display device 100 is able to transmit values of T_{RP} and T_{SR} together with the response signal, the electronic device 200 may calculate T_{reply A} of the display device 100. T_{round A}, which is an RTT of a signal transmitted by the display device 100 may be measured through the time T_{SR} when the response signal is transmitted and the time T_{RF} when the final signal is received. T_{P}, which is the ToA of the signal between the electronic device 200 and the display device 100, may be calculated by using Equation 1: T_{P}=(T_{round T}−T_{reply A})/2.

The distance between the electronic device 200 and the display device 100 may be calculated using the time Tₚ and the speed of the signal.

In operation 520, the display device 100 may obtain information about a distance between the plurality of antennas of the electronic device 200.

In this way, for example, a distance d1, a distance d2, and a distance b in FIG. 5C may be measured based on a ToA method used in UWB communication, and the processor 140 may obtain information about the distances in operations 510 and 520.

In operation 530, the display device 100 may determine information about a relative position of the electronic device 200 with respect to the display device 100. As described with reference to FIGS. 5B and 5C, the display device 100 may determine, based on information about a distance from each of the plurality of antennas of the electronic device 200 to the display device 100 (e.g., distance d1 and distance d2 in FIG. 5C) and information about a distance between the plurality of antennas (e.g., distance b in FIG. 5C), information about a distance d from the electronic device 200 to the display device 100 and an angle ψ1 formed between a direction from the electronic device 200 to the display device 100 and a direction based on positions of the plurality of antennas of the electronic device 200.

FIG. 5C is a diagram illustrating an operation of determining information about a relative position of a remote control device with respect to an electronic device as a reference, according to an embodiment. FIG. 5C may be based on a top down view of an indoor environment in which the display device 100 and the electronic device 200 operate. For example, FIG. 5C may be an X-Y plane looking down on an indoor environment in the +Z axis direction.

Referring to FIG. 5C, the processor 140 of the display device 100 may determine information about a relative position of the electronic device 200 with respect to the display device 100. The information about the relative position may include the distance d from the electronic device 200 to the display device 100, and an angle ø1 formed between a direction from the electronic device 200 to the display device 100 (a direction of a dashed line corresponding to d) and a direction based on positions of a plurality of antennas 211 and 212 of the electronic device 200 (a direction of a straight line 213).

According to an embodiment, the display device 100 may include the UWB antenna 115 as described with reference to FIG. 3, and the electronic device 200 may include UWB antennas 211 and 212 as described with reference to FIG. 2. Information about the distance b between the UWB antennas 211 and 212, distance d1, and distance d2 may be calculated. The information about the distance b, distance d1, and distance d2 may be obtained from the processor 140 of the display device 100, or may be obtained from the processor 240 of the electronic device 200 and transmitted to the display device 100.

Referring to FIG. 5C, the distance d and the angle ψ1 may be determined based on the distance b, the distance d1, and the distance d2. According to an embodiment, because the distance d1 and the distance d2 are each greater than the distance b by a threshold level or more, a straight line corresponding to the distance d1 may be considered parallel to a straight line corresponding to the distance d2. Therefore, the distance d may be determined to be equal to d1 or d2. In addition, the angle ψ1 may be determined by Equation 2: ψ1=cos−1(a/b).

Referring back to FIG. 4, in operation 430, the display device 100 may obtain a registered avatar image corresponding to the identified electronic device.

According to an embodiment, the display device 100 may include a database of registered avatar images corresponding to electronic devices, and the display device 100 may obtain an avatar image corresponding to the identified electronic device by referring to the database. The database of avatar images included in the display device 100 may correspond to one or more users, and include identification information of an electronic device corresponding to each user and a corresponding avatar image.

According to an embodiment, the server device 300 may include a database of registered avatar images corresponding to electronic devices, and the display device 100 may obtain an avatar image corresponding to the identified electronic device by requesting the avatar image from the server device 300. The database of avatar images included in the server device 300 may correspond to one or more users, and include identification information of an electronic device corresponding to each user and a corresponding avatar image.

According to an embodiment, the electronic device 200 may include a database of avatar images corresponding to the electronic device 200, and the display device 100 may obtain, from the electronic device 200, an avatar image corresponding to the electronic device 200.

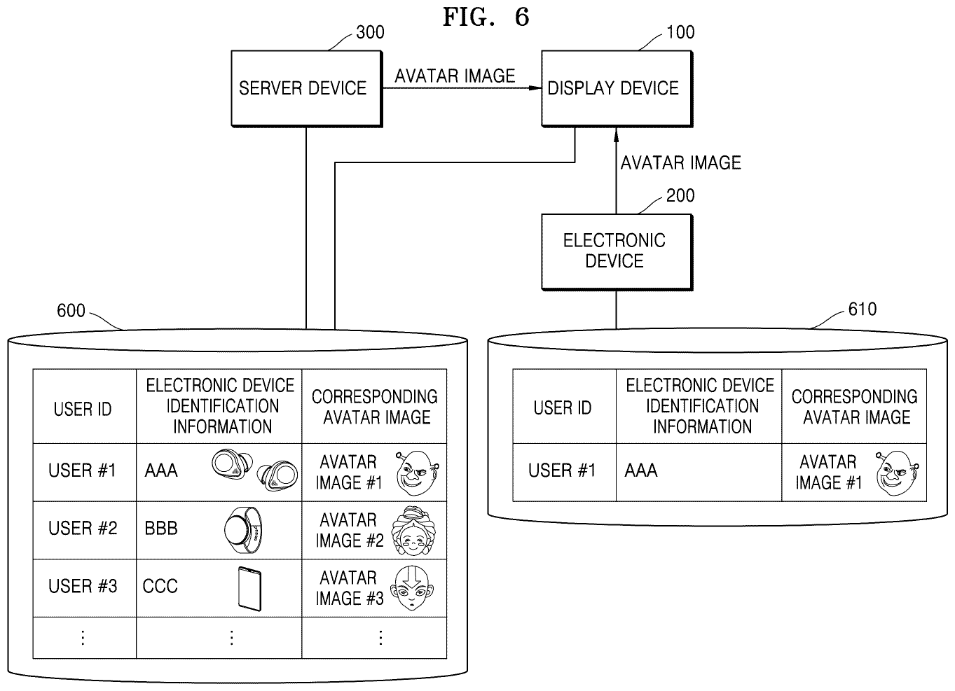

FIG. 6 is a reference diagram illustrating examples in which a display device obtains avatar images corresponding to electronic devices, according to an embodiment.

Referring to FIG. 6, according to an embodiment, the server device 300 may store an avatar image database 600 corresponding to electronic devices. The avatar image database 600 corresponding to the electronic devices may include registered avatar images corresponding to one or more users. For example, the avatar image database 600 corresponding to the electronic devices may store, for each user, a user ID, electronic device identification information, and a corresponding avatar image. Referring to FIG. 6, for user #1, electronic device identification information AAA corresponding to wireless earphones as an electronic device, and an avatar image #1 corresponding to the electronic device identification information AAA are registered. Furthermore, for user #2, electronic device identification information BBB corresponding to a smart watch as an electronic device, and an avatar image #2 corresponding to the electronic device identification information BBB are registered. In addition, for user #3, electronic device identification information CCC corresponding to a smartphone as an electronic device, and an avatar image #3 corresponding to the electronic device identification information CCC are registered.

For example, the users may register their avatar images to be associated with electronic devices they use by accessing the server device 300 using the display device 100 or the electronic device 200. In a case that the server device 300 stores such a database 600, the display device 100 may transmit obtained electronic device identification information to the server device 300 to request an avatar image corresponding to the electronic device identification information therefrom. In response to this request, the server device 300 may transmit the avatar image corresponding to the electronic device identification information to the display device 100.

According to an embodiment, the display device 100 may directly include an avatar image database 600 corresponding to electronic devices. In this case, the display device 100 may obtain an avatar image corresponding to the electronic device identification information by referencing the database 600 managed by the display device 100.

According to an embodiment, the electronic device 200 may store an avatar image database 610 corresponding to the electronic device 200. The avatar image database 610 corresponding to the electronic device 200 may include a registered avatar image corresponding to a user of the electronic device 200. For example, the avatar image database 610 corresponding to the electronic device may store, for each user, a user ID, electronic device identification information, and a corresponding avatar image. In this case, the electronic device 200 may transmit the avatar image corresponding to the electronic device 200 to the display device 100 via communication with the display device 100, and the display device 100 can obtain the avatar image corresponding to the electronic device 200, which is received from the electronic device 200.

Referring back to FIG. 4, in operation 440, the display device 100 may identify a user associated with the identified electronic device from the captured image.

According to an embodiment, the display device 100 may obtain location information of the user included in the captured image.

According to an embodiment, when the display device 100 captures an image by using a depth camera such as a ToF camera, the display device 100 may obtain location information of objects included in the image, such as the user included in the image.

According to an embodiment, the display device 100 may obtain location information of the user included in the captured image by using a skeleton detection technique.

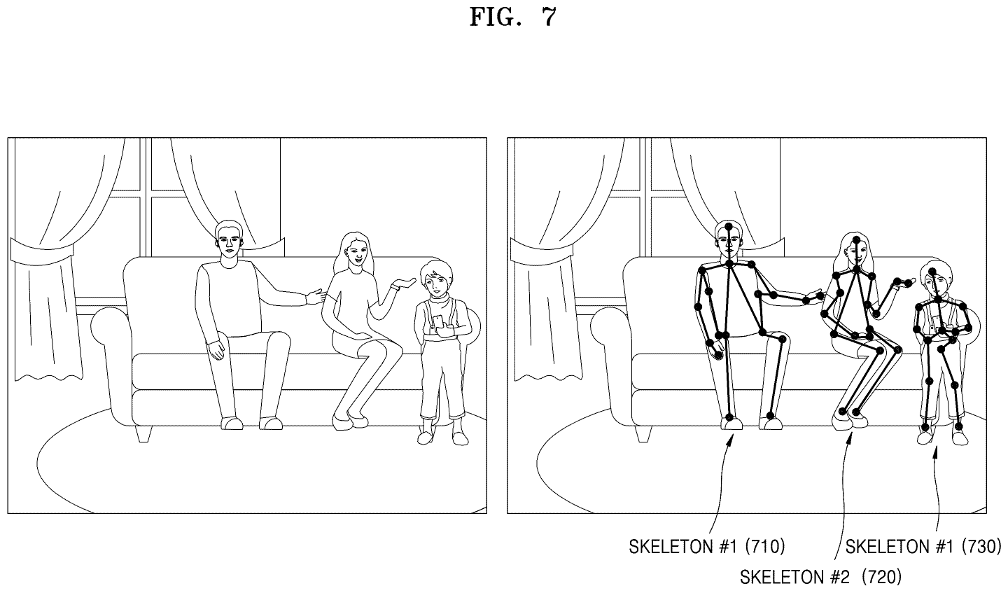

FIG. 7 is a reference diagram illustrating a method of detecting a user in a captured image by using a skeleton detection technique, according to an embodiment.

The display device 100 may include a skeleton detection module for detecting a skeleton in the captured image 10. The skeleton detection module may extract skeleton data of the user, which is composed of joints and bones, based on the skeleton in the image 10. Here, the skeleton data of the user may consist of a plurality of joints and bones, and may be data in which the plurality of joints and bones are set as a single set. The skeleton detection module may recognize a skeleton of the user in an image, and extract joints and bones based on the skeleton. The skeleton detection module may then extract skeleton data of the user by extracting spatial x, y, and z values for the joints from the skeleton data of the user. That is, the skeleton detection module may recognize each joint in three dimensions (3D) and extract coordinates of the joint in space. The skeleton detection module may use, for example, methods such as OpenPose, DensePose, video inference, and multi-task deep learning as a technique for estimating joint positions.

According to an embodiment, the display device 100 may identify the user associated with the identified electronic device by associating location information of the user included in the captured image with location information of the identified electronic device.

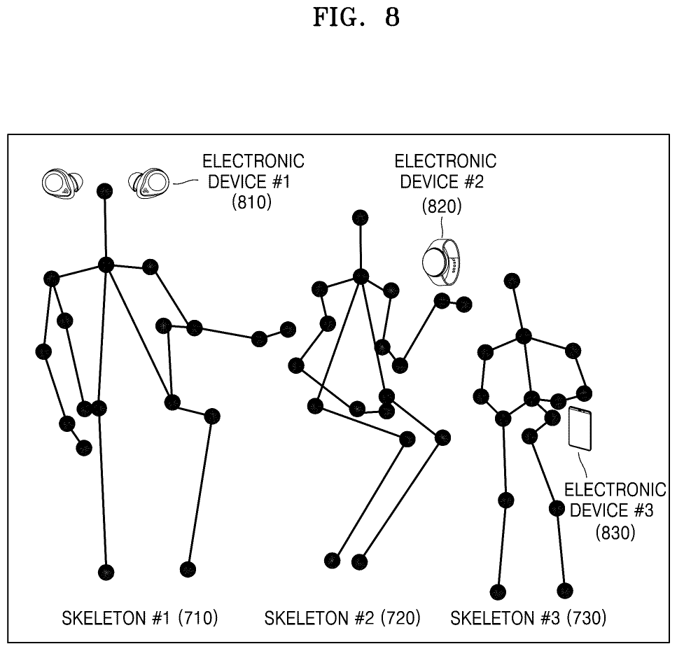

FIG. 8 is a reference diagram illustrating a method of identifying a user associated with an identified electronic device by associating location information of the user included in an image with location information of the identified electronic device, according to an embodiment.

Referring to FIG. 8, the display device 100 may identify a skeleton corresponding to an electronic device by aligning positions of one or more skeletons detected in a captured image by using a skeleton detection technique with positions of one or more identified electronic devices. The display device 100 may compare the positions of the one or more skeletons with the positions of the one or more electronic devices, and determine that an electronic device and a skeleton correspond to each other when a distance between the electronic device and the skeleton is less than or equal to a threshold. For example, in FIG. 8, when selecting a skeleton corresponding to an electronic device #1, the display device 100 may determine that a skeleton #1 corresponds to the electronic device #1 because the skeleton #1 is the skeleton whose distance from the electronic device #1 is less than or equal to the threshold. Furthermore, when selecting a skeleton corresponding to an electronic device #2, the display device 100 may determine that a skeleton #2 corresponds to the electronic device #2 because the skeleton #2 is the skeleton whose distance from the electronic device #2 is less than or equal to the threshold. When selecting a skeleton corresponding to an electronic device #3, the display device 100 may determine that a skeleton #3 corresponds to the electronic device #3 because the skeleton #3 is the skeleton whose distance from the electronic device #3 is less than or equal to the threshold. In this way, the display device 100 may select a skeleton corresponding to each electronic device in the image, i.e., a skeleton associated with each electronic device.

Thus, in this way, the display device 100 may identify a skeleton, i.e., a user, corresponding to each electronic device in the image.

Referring back to FIG. 4, in operation 450, the display device 100 may display an AR image by replacing at least a part of a body of the user identified in the image with an avatar image.

According to an embodiment, the display device 100 may display an AR image by replacing at least a part of the body of the user identified in the image with a registered avatar image corresponding to the electronic device associated with the user.

According to an embodiment, when the avatar image corresponds to a face, the display device 100 may display an AR image by replacing the face of the user identified in the image with the registered avatar image corresponding to the electronic device.

According to an embodiment, when the avatar image corresponds to the body including the face, the display device 100 may display an AR image by replacing the entire body of the user identified in the image with the registered avatar image corresponding to the electronic device.

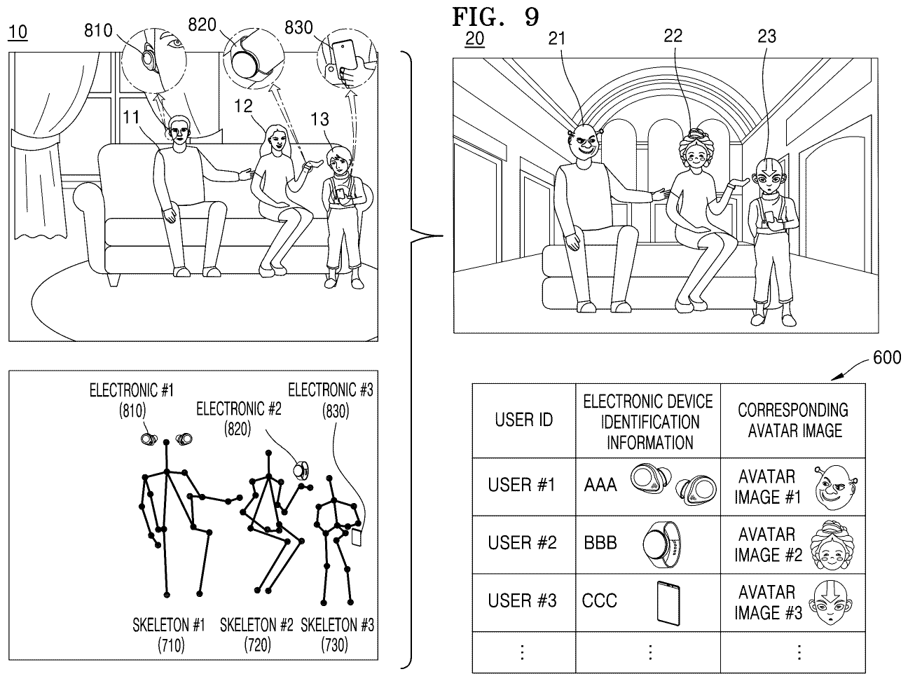

FIG. 9 illustrates an example of displaying an AR image by replacing a user included in an image with a registered avatar image corresponding to an electronic device associated with the user, according to an embodiment.

Referring to FIG. 9, the display device 100 may generate an AR image 20 by replacing a user included in an image 10 with a registered avatar image corresponding to an electronic device associated with the user.

According to an embodiment, the display device 100 may identify an electronic device associated with a skeleton based on a location of one or more skeletons detected in the image 10 and a location of one or more electronic devices. The display device 100 may then recognize at least a part of the user's body from the user corresponding to the skeleton, and replace the recognized at least part of the user's body with an avatar image corresponding to the identified electronic device.

According to an embodiment, the display device 100 may recognize at least a part of the user's body from an image of the user corresponding to the skeleton detected in the image 10 by using object detection technology, face recognition technology, or the like. At least a part of the user's body may include a face.

According to an embodiment, the display device 100 may obtain an avatar image corresponding to electronic device identification information by referring to the database 600 for the electronic device identification information.

According to an embodiment, the display device 100 may generate the AR image 20 by replacing at least a part of the user's body corresponding to the skeleton detected in the image 10 with an avatar image corresponding to the electronic device associated with the skeleton.

Referring to FIG. 9, for example, the display device 100 may replace a face of a user 11 corresponding to a skeleton #1 detected in the image 10 with an avatar image #1 corresponding to an electronic device #1 810 associated with the skeleton #1, replace a face of a user 12 corresponding to a skeleton #2 detected in the image 10 with an avatar image #2 corresponding to an electronic device #2 820 associated with the skeleton #2, and replace a face of a user 13 corresponding to a skeleton #3 detected in the image 10 with an avatar image #3 corresponding to an electronic device #3 830 associated with the skeleton #3.

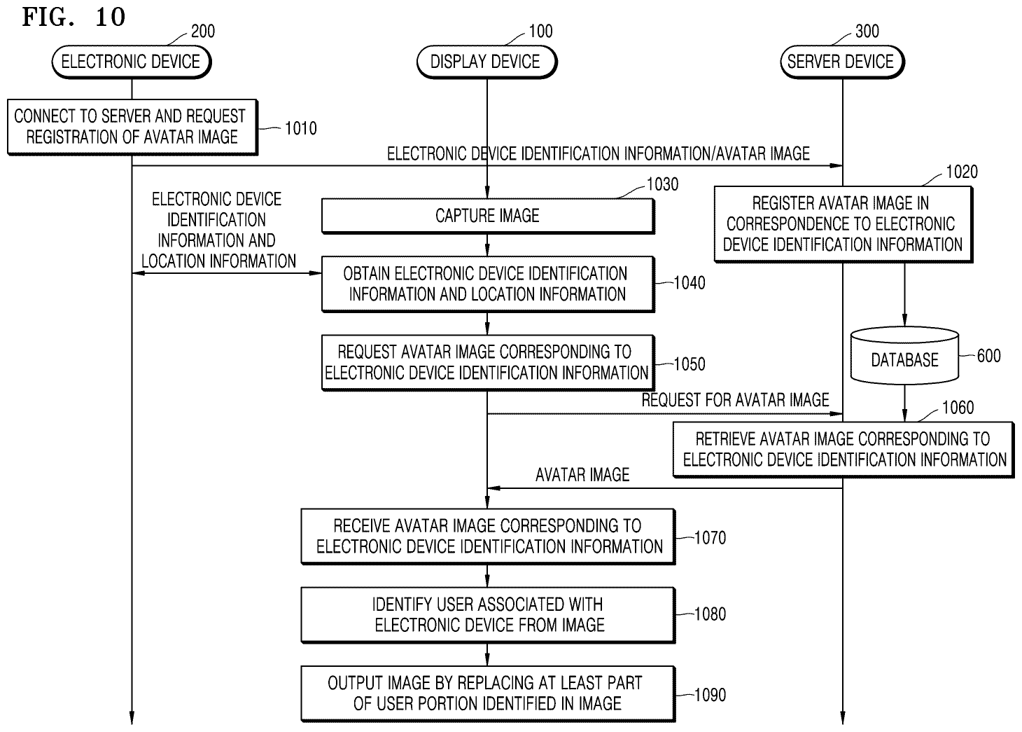

FIG. 10 is a flowchart of an example of an operation method of a display device for obtaining an avatar image from a server device, according to an embodiment.

Referring to FIG. 10, in operation 1010, a user of the electronic device 200 may connect to the server device 300 by using the electronic device 200 and request the server device 300 to map an avatar image representing the user to the electronic device 200.

In operation 1020, according to the request received from the electronic device 200, the server device 300 may store an avatar image in the database 600 in correspondence to electronic device identification information.

In operation 1030, the display device 100 may capture an image. Obtaining an image of an external environment by capturing the image of the external environment is as described in operation 410 of FIG. 4.

In operation 1040, the display device 100 may obtain electronic device identification information and location information of the electronic device 200 by communicating with the electronic device 200. Obtaining identification information and location information of the electronic device 200 by identifying the electronic device 200 via communication with the electronic device 200 is as described in operation 420 of FIG. 4.

In operation 1050, the display device 100 may request the server device 300 for an avatar image corresponding to the electronic device identification information.

In operation 1060, according to the request from the display device 100, the server device 300 may retrieve the avatar image corresponding to the electronic device identification information by referring to the database 600 and transmit the avatar image to the display device 100.

In operation 1070, the display device 100 may receive and obtain, from the server device 300, the avatar image corresponding to the electronic device identification information.

In operation 1080, the display device 100 may identify a user associated with the electronic device from the image. For example, the display device 100 may detect a skeleton in the image by using a skeleton detection technique, and identify a user associated with the electronic device based on location information of the detected skeleton and the location information of the electronic device. Identifying the user associated with the electronic device is as described with reference to operation 440 of FIG. 4.

In operation 1090, the display device 100 may replace at least a part of the user identified in the image with the avatar image registered for the electronic device associated with the user and output a resulting image.

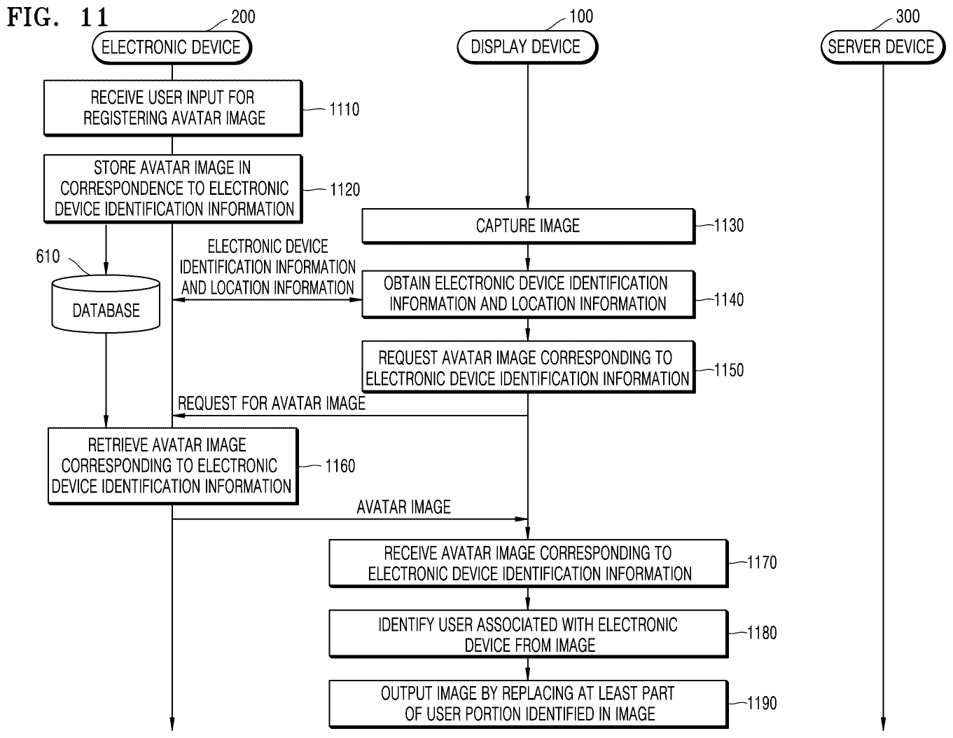

FIG. 11 is a flowchart of an example of an operation method of a display device for obtaining an avatar image from an electronic device, according to an embodiment.

Referring to FIG. 11, in operation 1110, the electronic device 200 may receive a user input for registering an avatar image of a user.

In operation 1120, the electronic device 200 may store an avatar image in the database 610 in correspondence to electronic device identification information according to the user input.

In operation 1130, the display device 100 may capture an image. Obtaining an image of an external environment by capturing the image of the external environment is as described in operation 410 of FIG. 4.

In operation 1140, the display device 100 may obtain electronic device identification information and location information of the electronic device 200 by communicating with the electronic device 200. Obtaining identification information and location information of the electronic device by identifying the electronic device 200 via communication with the electronic device 200 is as described in operation 420 of FIG. 4.

In operation 1150, the display device 100 may request the electronic device 200 for an avatar image corresponding to the electronic device identification information.

In operation 1160, according to the request from the display device 100, the electronic device 200 may retrieve the avatar image corresponding to the electronic device identification information by referring to the database 610 and transmit the avatar image to the display device 100.

In operation 1170, the display device 100 may receive and obtain, from the electronic device 200, the avatar image corresponding to the electronic device identification information.

In operation 1180, the display device 100 may identify a user associated with the electronic device from the image. For example, the display device 100 may detect a skeleton in the image by using a skeleton detection technique, and identify a user associated with the electronic device based on location information of the detected skeleton and the location information of the electronic device. Identifying the user associated with the electronic device is as described with reference to operation 440 of FIG. 4.

In operation 1190, the display device 100 may replace at least a part of the user identified in the image with the avatar image registered for the electronic device associated with the user and output a resulting image.

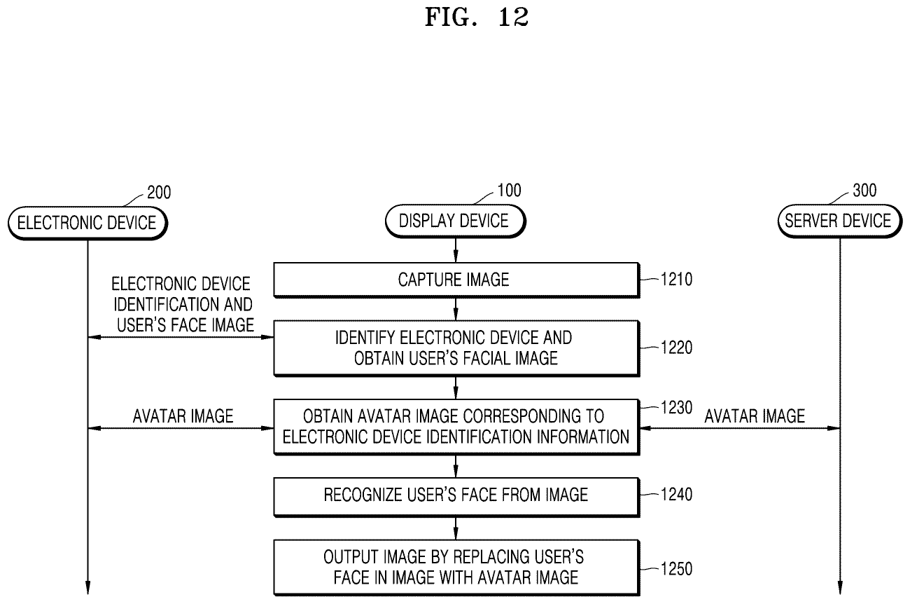

FIG. 12 is a flowchart of an example of an operation method of a display device for replacing a facial image with an avatar image, according to an embodiment.

Referring to FIG. 12, in operation 1210, the display device 100 may capture an image. Obtaining an image of an external environment by capturing the image of the external environment is as described in operation 410 of FIG. 4.

In operation 1220, the display device 100 may identify the electronic device 200 by communicating with the electronic device 200 and obtain, from the electronic device 200, a facial image of a user of the electronic device 200. Obtaining identification information and location information of the electronic device by identifying the electronic device 200 via communication with the electronic device 200 is as described in operation 420 of FIG. 4. The electronic device 200 may store a facial image of the user of the electronic device 200 and transmit the facial image of the user according to a request from the display device 100. Although the facial image of the user is used to substitute an avatar image, the user's facial image is stored in the electronic device 200, which is the user's personal device, and although the electronic device 200 transmits the user's facial image to the display device 100, the user's facial image transmitted in this manner is temporarily used to recognize the user's face from an image captured by the display device 100 and may be deleted after being used for face recognition. Therefore, the user's privacy concerns may not arise because the user's facial image is not stored in the display device 100.

In operation 1230, the display device 100 may obtain an avatar image corresponding to electronic device identification information by requesting the avatar image from the electronic device 200 or the server device 300. A method of obtaining an avatar image corresponding to electronic device identification information from the server device 300 is as described with reference to FIG. 10, and a method of obtaining an avatar image corresponding to electronic device identification information from the electronic device 200 is as described with reference to FIG. 11.

In operation 1240, the display device 100 may recognize the user's face in the image. Because the display device 100 has received and obtained, from the electronic device 200, the facial image of the user of the electronic device 200, the display device 100 may detect or recognize the user in the captured image by using the facial image of the user.

In operation 1250, the display device 100 may replace the user's face recognized in the image with the avatar image corresponding to the electronic device identification information and output a resulting image.

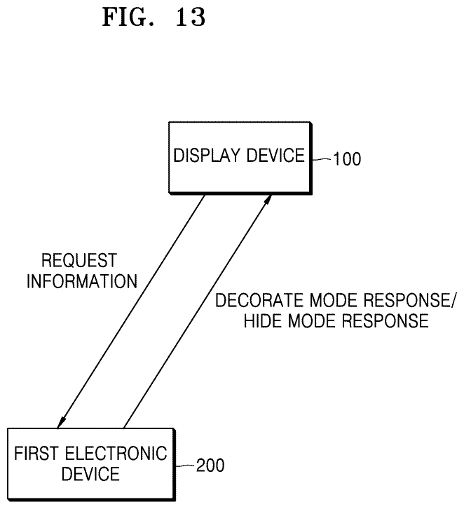

According to various embodiments, the user may select whether the user's face is displayed as an avatar or is hidden. For example, in a situation where a user of the display device 100 walks down the street while holding the AR-applied display device 100 and captures an image of a street environment, a street image captured by the display device 100 may include faces of one or more other users. Thus, privacy concerns may arise for anonymous users appearing in the street image captured by the display device 100. Therefore, in the disclosed embodiments, for each electronic device, a user of the corresponding electronic device may set an avatar display mode to one of a decorate mode and a hide mode, and according to these settings, the user of the electronic device may choose to be displayed as an avatar image or to be hidden when an image of the user is captured. An example of displaying an avatar by setting an avatar display mode to a decorate mode or a hide mode according to a user's selection is described with reference to FIGS. 13 to 15.

FIG. 13 is a reference diagram illustrating a concept of a method of displaying an avatar by setting an avatar display mode to a decorate mode or a hide mode based on a user's selection, according to an embodiment.

Referring to FIG. 13, the display device 100 represents a device that generates and displays an AR image by capturing an image of an external environment. The electronic device 200 is an object (actually a user holding the electronic device 200) included in an external environment and captured by the display device 100, and a user of the electronic device 200 may select an avatar display mode as one of a decorate mode and a hide mode according to his or her selection. The decorate mode may refer to a mode in which the user's face is displayed as an avatar image by replacing the user's face with the avatar image registered by the user when the user is captured by another device, i.e., the display device 100, and included in a captured image, and the hide mode may refer to a mode in which the user's face is hidden by performing mosaic processing, etc. when an image of the user is captured by the display device 100 and included in a captured image. For example, the user of the electronic device 200 may wish to have his or her appearance displayed as an avatar image in an image captured by an acquaintance, such as at a friend's house or his or her own home. In this case, the user of the electronic device 200 may set an avatar display mode to a decorate mode in the electronic device 200. For example, the user of the electronic device 200 may wish to have his or her appearance hidden in an image captured in a situation where an image of the user may be captured by strangers, such as on the street. In this case, the user of the electronic device 200 may set the avatar display mode to a hide mode in the electronic device 200.

In this way, when the avatar display mode is set to the hide mode or the decorate mode in the electronic device 200, the display device 100 may receive avatar display mode information of the electronic device 200 via communication with the electronic device 200. When the user of the electronic device 200 is included in the captured image, according to the set avatar display mode of the electronic device 20, the display device 100 may perform control to display the user of the electronic device 200 as an avatar image by replacing the user with the avatar image in response to the decorate mode and to hide the user of the electronic device 200 in response to the hide mode.

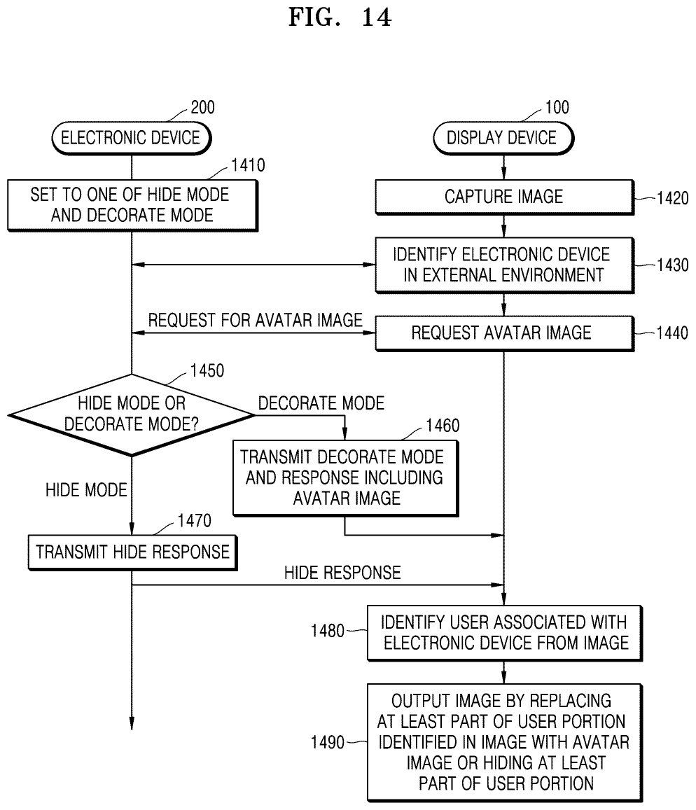

FIG. 14 is a flowchart of an example of an operation method of an electronic device and a display device based on an avatar display mode, according to an embodiment.

Referring to FIG. 14, in operation 1410, the electronic device 200 may set an avatar display mode to one of a hide mode and a decorate mode. For example, a user of the electronic device 200 may provide an input to the electronic device 200 to select the avatar display mode as one of a hide mode and a decorate mode based on the user's selection, thereby causing the electronic device 200 to set the avatar display mode to one of the hide mode and the decorate mode.

In operation 1420, the display device 100 may capture an image of an external environment.

In operation 1430, the display device 100 may identify the electronic device 200 by communicating with the electronic device 200. The display device 100 may identify the electronic device by obtaining identification information of the electronic device 200 and location information of the electronic device 200 by communicating with the electronic device 200.

In operation 1440, the display device 100 may request an avatar image from the identified electronic device 200.

In operation 1450, the electronic device 200 may receive the request for the avatar image from the display device 100 and determine whether the avatar display mode is set to a hide mode or a decorate mode.

When the avatar display mode is the decorate mode as a result of the determination, the electronic device 200 may perform operation 1460.

In operation 1460, the electronic device 200 may transmit a response including an avatar image to the display device 100 along with information indicating that it is in the decorate mode. Accordingly, the display device 100 may determine that the electronic device 200 is in the decorate mode, and store an avatar image corresponding to the electronic device 200.

In operation 1450, when the avatar display mode is the hide mode as a result of the determination, the electronic device 200 may perform operation 1470.

In operation 1470, the electronic device 200 may transmit a response indicating that it is in the hide mode to the display device 100. Accordingly, the display device 100 may determine that the electronic device 200 is in the hide mode and that a face of the user of the electronic device 200 is hidden.

In operation 1480, the display device 100 may identify a user associated with the electronic device from the image. A method of identifying a user associated with the electronic device 200 is as described with reference to operation 440 of FIG. 4.

In operation 1490, the display device 100 may output an image by replacing at least a part of the user identified in the captured image with an avatar image or hiding the part. The display device 100 may process the display of the avatar of the user of the electronic device 200 differently depending on the avatar display mode of the electronic device 200. When the avatar display mode of the electronic device 200 indicates the decorate mode, the display device 100 may process at least a part of the user identified in the image by replacing the at least the part of the user with an avatar image corresponding to the electronic device 200. When the avatar display mode of the electronic device 200 indicates the hide mode, the display device 100 may cause at least a part of the user identified in the image, i.e., the face, to be hidden by mosaics or the like. In this way, an AR image that is hidden or displayed as an avatar may be output.

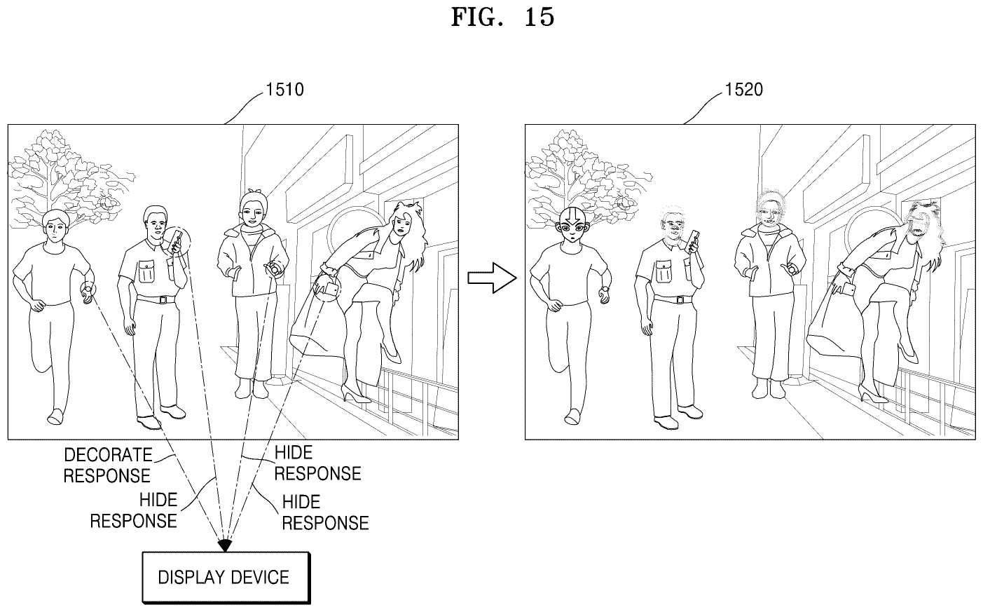

FIG. 15 is a reference diagram illustrating an example of outputting an image by hiding or displaying a user in a decorate mode based on an avatar display mode, according to an embodiment.

Referring to FIG. 15, the display device 100 is capturing a street view 1510 outdoors, and may perform communication with one or more electronic devices in an external environment while capturing the image, thereby obtaining electronic device identification information from one or more electronic devices that are within a communicable range. For example, as a result of the display device 100 performing communication with one or more electronic devices, i.e., a first electronic device 200a, a second electronic device 200b, a third electronic device 200c, and a fourth electronic device 200d, which are within a communicable range with the display device 100, the display device 100 may receive an avatar image with a decorate response from the first electronic device 200a, and receive hide responses from the remaining second electronic device 200b, third electronic device 200c, and fourth electronic device 200d.

Accordingly, the display device 100 may output an AR image 1520 generated by replacing a face of a user associated with the first electronic device 200a with an avatar image received from the first electronic device 200a and performing mosaic processing on faces of users associated with the second electronic device 200b, the third electronic device 200c, and the fourth electronic device 200d so that the users' faces are hidden.

In the above-described embodiments, a method based on communication with the electronic device 200 has been described as a method, performed by the display device 100, of identifying the electronic device 200. The disclosed embodiments are not limited thereto and may also utilize a barcode or Quick Response (QR) code. Similar examples to the QR code may include a colorzip code, a smart tag, a data matrix code, etc. As described above, when an avatar image corresponding to a barcode or QR code is pre-registered and such a barcode or QR code is recognized in an image captured at a later time, the pre-registered avatar image corresponding to the recognized barcode or QR code may be used to replace at least a part of a body of a user associated with the barcode or QR code.

Barcodes and QR codes may be respectively classified as one-dimensional (1D) codes and 2D codes. Barcode encoding includes a method of representing a single digit or a single character in the original text by a barcode as a combination of black and white bars, and a start code, an end code, a checksum digit, etc. are also included in the barcode. QR codes may be used when higher performance recognition is required because they have 20 to 40 times the information recording density of general barcodes and also include a data restoration capability. While general barcodes may store numeric or character information in one direction, i.e., one dimension, QR codes have a two-dimensional form in both vertical and horizontal directions, so they may hold more information, and are also capable of storing character data such as alphabets and Chinese characters in addition to numbers. To facilitate the representation and reading of data, a QR code is divided into areas such as a quiet zone, position detection patterns (including separators), timing patterns, alignment patterns, format information, version information, data area (including an error correction code area), etc.

Such barcodes and QR codes may be used to identify electronic devices or users. For example, if a barcode or QR code is included in an electronic device that a user is wearing or holding, or is included in clothing, a hat, gloves, etc. that the user is wearing, the display device 100 may recognize the barcode or QR code associated with the user in an image being captured. The display device 100 may then identify the user associated with the barcode or QR code recognized in this way. In this way, the display device 100 may output a pre-registered avatar image corresponding to the barcode or QR code by replacing at least a part of the user's body in the captured image with the pre-registered avatar image.

According to an embodiment, an operation method of a display device 100 may include obtaining an image by controlling a camera to perform image capturing. According to an embodiment, the operation method of the display device 100 may include identifying an electronic device by controlling a communication interface while performing the image capturing. According to an embodiment, the operation method of the display device 100 may include obtaining a registered avatar image corresponding to the identified electronic device. According to an embodiment, the operation method of the display device 100 may include identifying a user associated with the identified electronic device from the image. According to an embodiment, the operation method of the display device 100 may include generating and displaying an augmented reality image by replacing at least a part of a body of the user identified in the image with the avatar image.

According to an embodiment, the operation method of the display device 100 may further include obtaining location information of the electronic device and identification information of the electronic device by using BLE communication technology or UWB communication technology.

According to an embodiment, the operation method of the display device 100 may further include obtaining the avatar image by receiving, from a server, the registered avatar image corresponding to the electronic device, obtaining the avatar image from memory of the display device, or receiving the avatar image from the electronic device via the communication interface by using the identification information of the electronic device.

According to an embodiment, the operation method of the display device 100 may further include obtaining location information of the user included in the image by analyzing the image.

According to an embodiment, the operation method of the display device 100 may further include detecting one or more users in the image by performing skeleton detection on the image.

According to an embodiment, the operation method of the display device 100 may further include identifying a user associated with the electronic device by using location information of the user detected in the image and the location information of the electronic device.

According to an embodiment, the operation method of the display device 100 may further include identifying a user whose distance from the electronic device is less than or equal to a threshold as being the user associated with the electronic device.

According to an embodiment, the operation method of the display device 100 may further include receiving, from the electronic device, a facial image of a user of the electronic device and identifying the user associated with the electronic device by recognizing the facial image in the image.

According to an embodiment, the operation method of the display device 100 may further include receiving information about an avatar display mode from the electronic device, and hiding the user identified in the image or displaying an avatar of the user based on the information about the avatar display mode.

Some embodiments may be implemented in the form of recording media including instructions executable by a computer, such as a program module executable by the computer. The computer-readable recording media may be any available media that are accessible by the computer, and include both volatile and non-volatile media and both removable and non-removable media. Furthermore, the computer-readable recording media may include computer storage media. The computer storage media include both volatile and non-volatile and both removable and non-removable media implemented in any method or technology for storage of information, such as computer-readable instructions, data structures, program modules, or other data.

The disclosed embodiments may be implemented as a software program including instructions stored in computer-readable storage media.

A computer is a device capable of calling a stored instruction from a storage medium and performing an operation according to the disclosed embodiment in response to the called instruction, and may include an electronic device according to the disclosed embodiments.

A computer-readable storage medium may be provided in the form of a non-transitory storage medium. In this regard, the term ‘non-transitory’ only means that the storage medium does not include a signal and is a tangible device, and the term does not differentiate between where data is semi-permanently stored in the storage medium and where the data is temporarily stored in the storage medium.

Furthermore, operation methods according to the disclosed embodiments may be included in the form of a computer program product when provided. The computer program product may be traded, as a product, between a seller and a buyer.

The computer program product may include a software program and a computer-readable storage medium having the software program stored thereon. For example, the computer program product may include a product (e.g., a downloadable application) in the form of a software program electronically distributed by a manufacturer of a device or through an electronic market (e.g., Google Play Store™ and App Store™). For such electronic distribution, at least a part of the software program may be stored on the storage medium or may be temporarily generated. In this case, the storage medium may be a storage medium of a server of the manufacturer, a server of the electronic market, or a relay server for temporarily storing the software program.

In a system consisting of a server and a device, the computer program product may include a storage medium of the server or a storage medium of the device. Alternatively, in a case where there is a third device (e.g., a smartphone) communicatively connected to the server or the device, the computer program product may include a storage medium of the third device. Alternatively, the computer program product may include a software program itself that is transmitted from the server to the device or the third device or that is transmitted from the third device to the device.

In this case, one of the server, the device, and the third device may execute the computer program product to perform methods according to the disclosed embodiments. Alternatively, two or more of the server, the device, and the third device may execute the computer program product to perform the methods according to the disclosed embodiments in a distributed manner.

For example, the server (e.g., a cloud server or artificial intelligence (AI) server) may execute the computer program product stored therein to control the device communicatively connected to the server to perform the methods according to the disclosed embodiments.

In another example, the third device may execute the computer program product to control the device communicatively connected to the third device to perform the methods according to the disclosed embodiments. In a case where the third device executes the computer program product, the third device may download the computer program product from the server and execute the downloaded computer program product. Alternatively, the third device may execute the computer program product that is pre-loaded therein to perform the methods according to the disclosed embodiments.

Also, in this specification, the term “unit” may be a hardware component such as a processor or circuit, and/or a software component executed by a hardware component such as a processor.

The above description of the present disclosure is provided for illustration, and it will be understood by one of ordinary skill in the art that changes in forms or details may be readily made therein without departing from technical idea or essential features of the present disclosure. Accordingly, the above-described embodiments and all aspects thereof are merely examples and are not limiting. For example, each component defined as an integrated component may be implemented in a distributed fashion, and likewise, components defined as separate components may be implemented in an integrated form.

The scope of the present disclosure is defined not by the detailed description thereof but by the following claims, and all the changes or modifications within the meaning and scope of the appended claims and their equivalents should be construed as being included in the scope of the present disclosure.

What is claimed is:

1. A display device comprising:
a communication interface;
a display;
a camera;
at least one processor including processing circuitry;
memory storing one or more instructions; and
wherein the one or more instructions are configured to, when executed by the at least one processor individually or collectively, cause the display device to:
obtain an image using the camera,
identify an electronic device by controlling the communication interface while obtaining the image,
obtain a registered avatar image associated with the electronic device,
identify a user associated with the electronic device based on the image, and
generate and display an augmented reality image associated with the image based on replacing at least a part of the user in the image with the registered avatar image.

2. The display device of claim 1, wherein the one or more instructions are configured to, when executed by the at least one processor individually or collectively, further cause the display device to obtain location information of the electronic device and identification information of the electronic device by using Bluetooth Low Energy (BLE) communication technology or ultra-wideband (UWB) communication technology.

3. The display device of claim 2, wherein the one or more instructions are configured to, when executed by the at least one processor individually or collectively, further cause the display device to obtain the registered avatar image by one of:
receiving, from a server, the registered avatar image associated with the electronic device,
obtaining the registered avatar image from the memory of the display device, or
receiving the registered avatar image from the electronic device via the communication interface based on the identification information of the electronic device.

4. The display device of claim 1, wherein the one or more instructions are configured to, when executed by the at least one processor individually or collectively, further cause the display device to obtain location information of the user included in the image by processing the image.

5. The display device of claim 1, wherein the one or more instructions are configured to, when executed by the at least one processor individually or collectively, further cause the display device to detect one or more users in the image based on a skeleton detection processing of the image.

6. The display device of claim 2, wherein the one or more instructions are configured to, when executed by the at least one processor individually or collectively, further cause the display device to identify the user associated with the electronic device based on location information of the user detected in the image and the location information of the electronic device.

7. The display device of claim 1, wherein the one or more instructions are configured to, when executed by the at least one processor individually or collectively, further cause the display device to identify a first user whose distance from the electronic device is less than or equal to a threshold as being the user associated with the electronic device.

8. The display device of claim 1, wherein the one or more instructions are configured to, when executed by the at least one processor individually or collectively, further cause the display device to:
receive, from the electronic device, a facial image of the user associated with the electronic device, and
identify the user associated with the electronic device by identifying the facial image in the image.

9. The display device of claim 1, wherein the one or more instructions are configured to, when executed by the at least one processor individually or collectively, further cause the display device to:
receive, from the electronic device, information about an avatar display mode, and
conceal the user identified in the image or display the registered avatar image of the user based on the information about the avatar display mode.

10. The display device of claim 9, wherein the one or more instructions are configured to, when executed by the at least one processor individually or collectively, further cause the display device to:
based on the avatar display mode indicating a decorate mode, display at least the part of the user identified in the image as the registered avatar image, and
based on the avatar display mode indicating a hide mode, conceal at least the part of the user identified in the image.

11. An operation method of a display device, the operation method comprising:
obtaining an image using a camera;
identifying an electronic device by controlling a communication interface while obtaining the image;
obtaining a registered avatar image associated with the electronic device;
identifying a user associated with the electronic device based on the image; and
generating and displaying an augmented reality image associated with the image based on replacing at least a part of the user in the image with the registered avatar image.

12. The operation method of claim 11, further comprising obtaining location information of the electronic device and identification information of the electronic device by using Bluetooth Low Energy (BLE) communication technology or ultra-wideband (UWB) communication technology.

13. The operation method of claim 11, further comprising obtaining the registered avatar image by one of:
receiving, from a server, the registered avatar image associated with the electronic device,
obtaining the registered avatar image from memory of the display device, or
receiving the registered avatar image from the electronic device via the communication interface based on identification information of the electronic device.

14. The operation method of claim 11, further comprising:
obtaining location information of the user included in the image by processing the image.

15. A non-transitory computer-readable recording medium storing one or more instructions, the one or more instructions that when executed by a processor of a display device, cause the processor to:
obtain an image using a camera,
identify an electronic device by controlling a communication interface while obtaining the image,
obtain a registered avatar image associated with the electronic device,
identify a user associated with the electronic device based on the image, and
generate and display an augmented reality image associated with the image based on replacing at least a part of the user in the image with the registered avatar image.
